(19) United States
(12) Patent Application Publication
(10) Pub. No.: US 2012/0069833 A1
(43) Pub. Date: Mar. 22, 2012

(54) CHANNEL STATE INFORMATION REPORTING FOR A SUCCESSIVELY DECODED, PRECODED MULTI-ANTENNA TRANSMISSION

(76) Inventor: Karl J. Molnar, Cary, NC (US)

(21) Appl. No.: 12/883,482

(22) Filed: Sep. 16, 2010

(51) Int. Cl. H04B 7/216

(52) U.S. Cl. 370/342

(57) ABSTRACT

Teachings herein provide reduced complexity channel state information (CSI) reporting for a successively decoded, precoded multi-antenna transmission. A wireless communication device reports CSI by forming, for each candidate transmission rank of the transmission, a sequence of codewords by iteratively adding codewords allowed for that rank to the sequence. At any given point in the sequence, the device adds the codeword expected to yield the highest individual information rate if decoded at that point in the sequence, considering the different rates possible under different precodings of the transmission. The device then computes, for each rank, a sum information rate across the codewords in the sequence formed for that rank, selects the rank having the highest sum information rate, and reports the selected rank along with the sequence formed for that rank. CSI reporting complexity is reduced because the device constrains its evaluation to only some of the possible decoding sequences.

### TECHNICAL FIELD

The present invention relates generally to channel state information (CSI) reporting in a wireless communication system and, more particularly, to CSI reporting for a successively decoded, precoded multi-antenna transmission.

### BACKGROUND

Wireless communication systems are required to transmit ever-increasing amounts of information in support of expanded subscriber services, such as messaging, e-mail, video streaming, and the like. Transmitting a higher amount of information over a given communication channel requires transmission at a higher information rate.

One multi-antenna technique to improve information rates is spatial multiplexing, which is a form of multiple input, multiple output (MIMO). By using multiple antennas at both the transmitter and receiver, spatial multiplexing exploits the spatial dimension of the communication channel to create several parallel subchannels (i.e., layers) within a single time-frequency resource. Over these parallel subchannels, two or more data streams can be simultaneously transmitted to the receiver, yielding a higher information rate than if just one stream was used.

The particular number of layers transmitted (i.e., the transmission'rank) is dynamically adapted to the actual usable rank of the channel. This process, referred to as rank adaptation, often requires the receiver to determine the rank of the channel, calculate the highest transmission rank that both the channel and the receiver can support (e.g., to maximize the data rate), and then report back that transmission rank to the transmitter as a recommendation (i.e., as rank information, RI). The transmitter may then take the receiver's recommendation into account when deciding on what transmission rank to actually use for the transmission.

In order to orthogonalize parallel transmission of multiple layers, and thus reduce interference among them, the transmitter “precodes” the transmission. This precoding process typically requires the receiver to determine the precoding that the transmitter should apply for diagonalization of the channel matrix and to report back that precoding to the transmitter as a recommendation (i.e., as precoding matrix information, PMI). Because the bandwidth for such feedback is limited, though, the receiver may report back the precoding as simply an index into a pre-defined set of possible precodings (i.e., a codebook) known to both the transmitter and receiver. As there may be different sets of possible precodings (i.e., sub-codebooks) for different transmission ranks, the transmitter may determine the recommended precoding based on the reported PMI as well as the reported RI. Also, while the receiver practically reports back only a single RI that is valid for the entire transmission bandwidth, the receiver may report back multiple PMIs valid for different parts (i.e., sub-bands) of the transmission bandwidth (e.g., the receiver may recommend different precodings for different sub-bands).

With the transmission precoded in this way, each layer may have a different ‘quality’ depending on the channel matrix. This suggests potential benefits in separately adapting the modulation and coding for at least some of the layers. In this regard, a multi-codeword (MCW) approach maps multiple different codewords to the layers (in some cases, a single codeword may be mapped to or split across several layers rather than being mapped to just one layer). Each codeword is independently modulated and coded by the transmitter based on channel quality reports from the receiver. Specifically, the receiver reports a channel quality information (CQI) value for each codeword which directly or indirectly indicates a recommended modulation type for that codeword among other transmission parameters. The transmitter then separately adapts the transmission parameters for the codewords based on the reported CQI values, and then maps each codeword to one or more layers.

This MCW approach may be utilized in conjunction with receiver-side processing to reduce any residual interference among the layers that may remain despite the use of precoding at the transmitter. In particular, a receiver may employ successive interference cancellation (SIC) techniques to successively decode the codewords of the transmission in a certain sequence. The first codeword is decoded by a first decoding stage that treats all other codewords as interference. The decoded codeword is then regenerated (i.e., re-encoded), so that its contribution to the received transmission can be determined and subtracted out. This effectively eliminates the first codeword's interference to the other codewords in the sequence, and thus improves the receiver's ability to decode those codewords. Successive decoding of the remaining codewords continues in an analogous manner with successive decoding stages.

Although SIC reception in conjunction with a MCW approach proves quite advantageous for increasing information rates, it greatly complicates the receiver's reporting of channel state information. Specifically, the receiver often must report multiple CQI values, one for each codeword transmitted, rather than just one CQI value, and in some cases must report a large number of PMIs, one for each sub-band of the transmission. The receiver must also report the specific decoding sequence assumed for the reported CQI values, PMIs, and RI. In addition to increasing the bandwidth required for the report, this means that the receiver must evaluate every possible combination of CQI values, PMI(s), RI, and decoding sequence to obtain optimal performance. The high complexity of such a task prohibits its implementation in some devices, e.g., mobile devices, and in any event severely limits the number of codewords that can be simultaneously transmitted (e.g., to only two).

### SUMMARY

Teachings herein advantageously provide reduced complexity channel state information (CSI) reporting for a successively decoded, precoded multi-antenna transmission. The teachings evaluate a substantially reduced number of possible decoding sequences, as compared to prior reporting approaches, yet still offer near-optimal transmission rates. With reporting complexity reduced in this way, a greater number of codewords can be simultaneously transmitted.

More particularly, a wireless communication device as taught herein includes two or more receive antennas, receive (RX) processing circuits, and a CSI reporting circuit. The two or more receive antennas are configured to receive a forthcoming precoded, multi-antenna transmission. With this multi-antenna transmission including one or more codewords, the RX processing circuits are configured to successively decode those codewords in a certain sequence, e.g., using successive interference cancellation (SIC). In advance of receiving this transmission, though, the CSI reporting circuit is configured to report or feed back CSI to the transmitter, in order to achieve the highest information rate possible for the transmission. This CSI may include, for example, a recommended transmission rank and a corresponding decoding sequence.

To report CSI such as this, the CSI reporting circuit is configured to form a sequence of codewords for each of a plurality of candidate transmission ranks of the transmission. The CSI reporting circuit forms the sequence of codewords for any given candidate transmission rank by iteratively adding codewords allowed for that rank to the sequence. The specific order in which the CSI reporting circuit iteratively adds codewords to that sequence may be in the reverse order from which they would be detected using SIC reception. For example, the codeword detected by the last decoding stage may be added first, to the end of the sequence, followed by the codeword detected by the next-to-last decoding stage, and so on.

In determining which of the allowed codewords to add at a particular point in the sequence (e.g., during a particular iteration), the CSI reporting circuit adds the codeword expected to yield the highest individual information rate if decoded at that point in the sequence; that is, if decoded by decoding, re-encoding, and subtracting from the transmission those codewords not yet added to the sequence and cancelling any interference due to those codewords already added to the sequence (e.g., during a previous iteration). In doing so, the CSI reporting circuit considers the various different individual information rates possible for a codeword under different precodings of the transmission.

Having formed sequences of codewords in this way, the CSI reporting circuit computes, for each candidate transmission rank, a sum information rate across the codewords in the sequence formed for that rank. A sum information rate thus in a sense represents the highest information rate expected for a given candidate transmission rank. Aiming of course to achieve the highest information rate possible, the CSI reporting circuit selects the candidate transmission rank having the highest sum information rate, and reports CSI indicating the selected transmission rank and the sequence of codewords formed for that rank.

By reporting CSI as described above, the CSI reporting circuit constrains its evaluation to only some of the possible sequences in which the transmission's codewords may be decoded. Yet because these decoding sequences are intelligently formed as the most likely sequences to yield the highest information rate for their respective transmission ranks, the CSI reporting circuit has reduced complexity while still offering near-optimal information rates.

In some embodiments, the CSI reporting circuit also reports additional information other than the selected transmission rank and decoding sequence. For example, the CSI reporting circuit may report the precoding of the transmission and/or channel quality information (CQI) values associated with the selected transmission rank and corresponding decoding sequence. In these embodiments the CSI reporting circuit can therefore be understood as jointly determining transmission rank, decoding sequence, precoding, and CQI values based on the constrained evaluation of possible decoding sequences described above.

In any event, the precoding and CQI values may be reported on a wideband basis, i.e., applicable to all parts (i.e., sub-bands) of the transmission bandwidth, or on a per sub-band basis. In particularly advantageous embodiments that report precoding and CQI values on a per sub-band basis, to facilitate frequency selective scheduling of the transmission, the CSI reporting circuit nonetheless forms decoding sequences and selects transmission rank based on wideband information rates. That is, instead of deciding whether to add a codeword to a sequence based on the codeword's information rate in any given sub-band, which would impermissibly yield different decoding sequences for different sub-bands, the CSI reporting circuit makes the decision based on a sum rate across all sub-bands.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication device configured to report channel state information for a successively decoded, precoded multi-antenna transmission according to various embodiments of the present invention.

FIG. 2 is a logic flow diagram of a method of channel state information reporting for a successively decoded, precoded multi-antenna transmission according to various embodiments of the present invention.

FIG. 3 is a block diagram of an example transmitter which receives the channel state information reported before transmitting the precoded multi-antenna transmission to the device of FIG. 1.

FIG. 4 is a logic flow diagram of a method of channel state information reporting that considers different possible precodings of the transmission in different sub-bands of the transmission's bandwidth.

### DETAILED DESCRIPTION

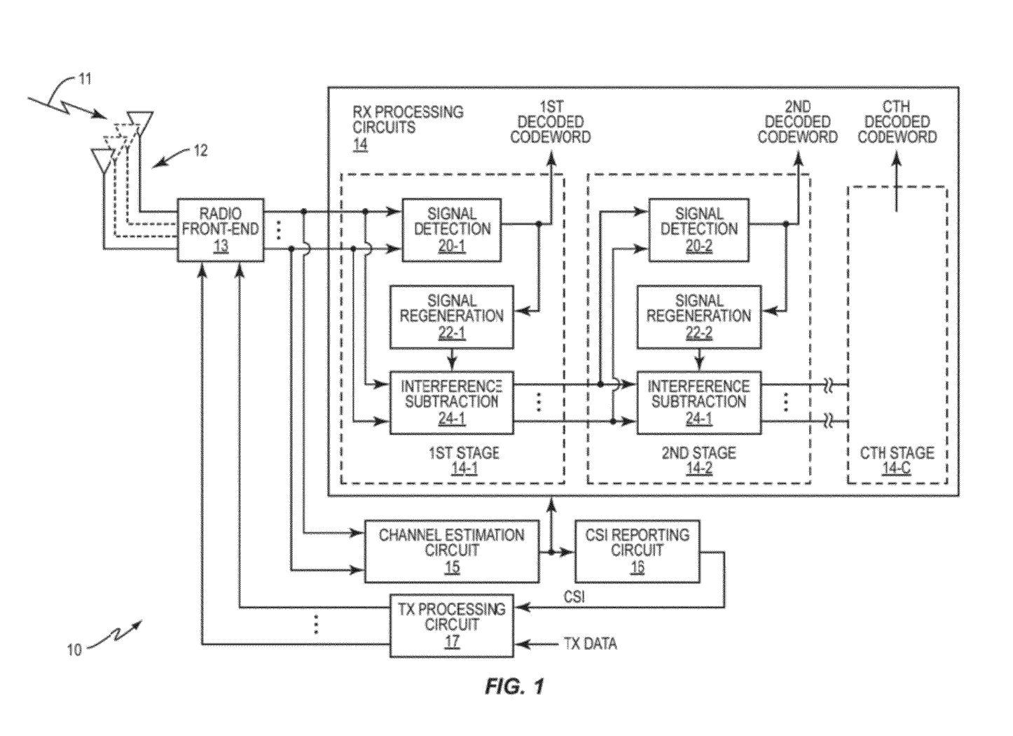

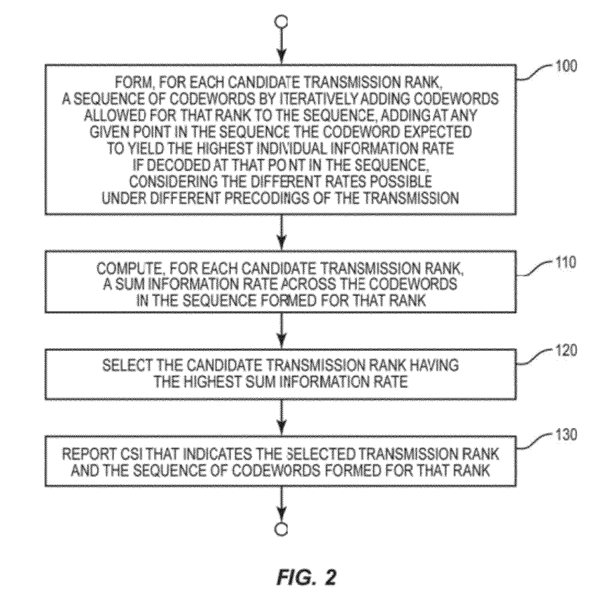

FIG. 1 illustrates a wireless communication device 10 configured to report information about the state of a communication channel to a transmitter, in advance of receiving a precoded multi-antenna transmission 11 over that channel. This reported information, referred to as channel state information (CSI), includes a certain sequence or ‘order’ in which the device 10 may successively decode various codewords of the transmission 11, when the transmission 11 is eventually received, to achieve the highest information rate. Notably, the device 10 estimates this decoding order with relatively low complexity by evaluating only some of the possible decoding sequences, rather than all of them.

In more detail, the main functional components of the wireless communication device 10 include two or more receive antennas 12, receive (RX) processing circuits 14, and a CSI reporting circuit 16. The two or more receive antennas 12 are configured to receive the forthcoming precoded, multi-antenna transmission 11 over the channel. The channel comprises one or more subchannels (within a single time-frequency resource), over which one or more data streams (i.e., layers) may be simultaneously transmitted. The multi-antenna transmission 11 received thus includes one or more codewords that have been mapped onto these layers, with each codeword having been separately modulated and coded. The multi-antenna transmission 11 has also been precoded to orthogonalize parallel transmission of the layers. Having received such a transmission 11, the receive antennas 12 provide the transmission 11 via radio front-end 13 to the RX processing circuits 14.

The RX processing circuits 14 are configured to successively decode the codewords of the transmission 11 in a certain sequence, which may be for example a sequence that device 10 has reported to the transmitter. Such RX processing may be referred to a successive interference cancellation (SIC). In particular, the RX processing circuits 14 comprise successive decoding stages 14-1 through 14-C, where C is the number of codewords included in the transmission 11. These stages 14-1 through 14-C provide successive decoding of the transmission's codewords and further provide successive cancellation of interference from the decoded codewords, so that later stages benefit from the decoding and interference cancellation in prior stages.

For example, in the illustrated configuration, stage 14-1 includes a signal detection circuit 20-1, a signal regeneration circuit 22-1, and an interference subtraction circuit 24-1. Upon receiving the transmission 11 from the receive antennas 12, signal detection circuit 20-1 decodes the first codeword in the decoding sequence, treating all other codewords as interference. If decoding is successful, signal regeneration circuit 22-1 regenerates (e.g., re-encodes) that first codeword, so that interference subtraction circuit 24-1 can estimate the interference due to the first codeword and subtract the estimated interference from the received transmission 11. The transmission 11, with the first codeword's interference removed, is then provided to the next stage 14-2.

Stage 14-2 likewise includes a signal detection circuit 20-2, a signal regeneration circuit 22-2, and an interference subtraction circuit 24-2. Upon receiving the transmission 11 from stage 14-1, signal detection circuit 20-2 decodes the second codeword in the decoding sequence, treating all remaining codewords as interference. If decoding is successful, signal regeneration circuit 22-2 regenerates that second codeword, so that interference subtraction circuit 24-2 can estimate the interference due to the second codeword and subtract the estimated interference from the transmission 11. The transmission 11, with the first and second codewords' interference removed, is then provided to the next stage. Successive decoding and interference cancellation proceeds in a similar manner at this next stage, and at all remaining stages, until all codewords of the transmission 11 have been decoded. Of course, note that no interference cancellation is needed once the final codeword is decoded, so stage 14-C does not include a signal regeneration circuit 22-C or an interference subtraction circuit 24-C.

With this general understanding of how the RX processing circuits 14 will successively decode the codewords of the transmission 11 in a certain sequence, one may appreciate how the CSI reporting circuit 16 reports CSI in advance of that transmission 11, in order to achieve the highest information rate possible. In particular, the CSI reporting circuit 16 acquires an estimate of the channel response from a channel estimation circuit 15 also included in the device 10. This channel estimate may be based on, for example, previously received reference symbols known a priori by both the transmitter and the device 10. Utilizing this channel estimate, the CSI reporting circuit 16 generally performs the method shown in FIG. 2.

In FIG. 2, the CSI reporting circuit 16 forms a sequence of codewords for each of a plurality of candidate transmission ranks of the transmission 11 (Block 100). These candidate transmission ranks may include all of the possible transmission ranks of the transmission 11, that is all of the possible number of layers of the transmission 11, or only a pre-determined subset of the possible transmission ranks. In either case, the CSI reporting circuit 16 forms the sequence of codewords for any given candidate transmission rank by iteratively adding codewords allowed for that rank to the sequence. The order in which the CSI reporting circuit 16 iteratively adds codewords to that sequence may be in the reverse order from which they would be detected using SIC reception (that is, the codeword detected by the last decoding stage 14-C may be added first, to the end of the sequence, followed by the codeword detected by the next-to-last decoding stage, and so on).

More particularly, in determining which of the allowed codewords to add at a particular point in the sequence (e.g., during a particular iteration), the CSI reporting circuit 16 adds the codeword expected to yield the highest individual information rate if decoded at that point in the sequence; that is, if decoded by decoding, re-encoding, and subtracting from the transmission 11 those codewords not yet added to the sequence and cancelling any interference due to those codewords already added to the sequence (e.g., during a previous iteration). In doing so, the CSI reporting circuit 16 considers the various different individual information rates possible for a codeword under different precodings of the transmission 11.

Having formed sequences of codewords in this way, the CSI reporting circuit 16 computes, for each candidate transmission rank, a sum information rate across the codewords in the sequence formed for that rank (Block 110). A sum information rate thus in a sense represents the highest information rate expected for a given candidate transmission rank. Aiming of course to achieve the highest information rate possible, the CSI reporting circuit 16 selects the candidate transmission rank having the highest sum information rate (Block 120), and reports CSI indicating the selected transmission rank and the sequence of codewords formed for that rank (Block 130).

By reporting CSI as described above, the CSI reporting circuit 16 constrains its evaluation to only some of the possible sequences in which the transmission's codewords may be decoded. In fact, by iteratively forming a single decoding sequence for each candidate transmission rank and using just those sequences to determine the CSI, the CSI reporting circuit 16 only evaluates as many decoding sequences as there are candidate transmission ranks. Yet because these decoding sequences are intelligently formed as the most likely sequences to yield the highest information rate for their respective transmission ranks, the CSI reporting circuit 16 has reduced complexity while still offering near-optimal information rates. With reporting complexity reduced in this way, the receiver 10 may be able to simultaneously receive a greater number of codewords (e.g., more than two) as compared to prior art receivers.

Of course, while the CSI reporting circuit 16 was generally described above as reporting just the selected transmission rank and the decoding sequence formed for that rank, the circuit 16 in some embodiments also reports additional information. In at least one embodiment, for example, the CSI reporting circuit 16 also reports the precoding of the transmission 11 associated with the selected transmission rank and corresponding decoding sequence; that is, the precoding that yields the highest individual information rate expected for each codeword in the sequence formed for the selected transmission rank.

In at least one other embodiment, the CSI reporting circuit 16 also reports channel quality information (CQI) values associated with the selected transmission rank and corresponding decoding sequence. In such embodiments, when the CSI reporting circuit 16 is determining whether to add a given codeword at a particular point in a sequence, the circuit 16 further considers the different rates possible for that codeword under different modulation and coding schemes (MCSs). Then, when reporting the selected transmission rank and the corresponding decoding sequence, the CSI reporting circuit 16 also reports CQI values for the codewords in the sequence, based on the MCSs for the codewords that yielded the highest individual information rate for those codewords.

Accordingly, in embodiments such as these, the CSI reporting circuit 16 can be understood as jointly determining transmission rank, decoding sequence, precoding, and CQI values based on the constrained evaluation of possible decoding sequences described above. In this sense, complexity reductions are particularly significant, as the number of iterations over which possible precodings and MCSs must be considered is drastically reduced.

Regardless of whether the CSI reported includes just the transmission rank and decoding sequence, or also the precoding and CQI values, the CSI reporting circuit 16 may report the CSI by providing that CSI to transmit (TX) processing circuits 17 included in the device 10, as shown in FIG. 1. The TX processing circuits 17 then process (e.g., encode, symbol map, etc.) the CSI and any other TX data for transmission over transmit antenna(s) of the device 10, which may be the same as receive antennas 12.

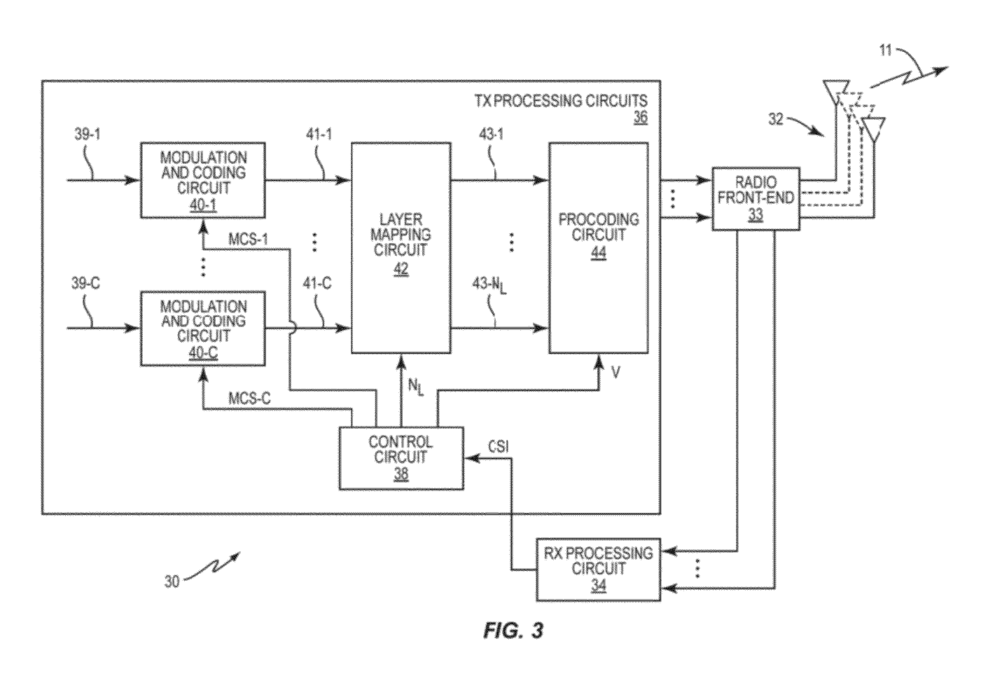

An example of a transmitter which receives this CSI before transmitting the precoded multi-antenna transmission 11 to the device 10 is shown in FIG. 3. The main functional components of this transmitter 30 include two or more transmit antennas 32, RX processing circuits 34, and TX processing circuits 36. The RX processing circuits 34 process (e.g., de-modulate, de-code, etc.) the transmission received from the device 10 and provide the recovered CSI to a control circuit 38 for the TX processing circuits 36. The control circuit 38 takes the CSI into account, but in some embodiments does not have to follow it, when deciding on the rank, precoding, and MSCs to use for the precoded multi-antenna transmission 11.

In more detail, the TX processing circuits 36 also include modulation and coding circuits 40-1 through 40-C (where, again, C is the number of codewords in the transmission 11), a layer mapping circuit 42, and a precoding circuit 44. The modulation and coding circuits 40-1 . . . 40-C accept as input respective data or ‘transport’ blocks 39-1 through 39-C, and then separately process (e.g., encode, scramble, modulate, etc.) those transport blocks 39-1 . . . 39-C in accordance with MCSs, MCS-1 . . . MCS-C, selected by the control circuit 38. The control circuit's selection of MCS-1 . . . MCS-C may be based directly or indirectly on CQI values received from the device 10.

The layer mapping circuit 42 maps the resulting codewords 41-1 through 41-C to one or more layers 43-1 through 43-N_{L}, where N_{L} represents the transmission rank of the transmission 11 and is selected by the control circuit 38. Again, the control circuit's selection of the transmission rank N_{L} may be based directly or indirectly on the transmission rank reported by the device 10. In either case, the layer mapping circuit 42 may map any given codeword 41 to one or more layers 43, such that the modulation symbols of that codeword 41 are split among those layers.

The precoding circuit 44 then precodes the transmission 11 in accordance with a precoding selected by the control circuit 38, in order to orthogonalize the parallel transmission of layers 43-1 . . . 43-N_{L} over the channel. More particularly, the precoding applied by the precoding circuit 11 may be based on the singular-value decomposition (SVD) of the channel:

H=UDV^{H} (1)

where U and V are matrices whose columns are orthonormal and D is a diagonal matrix with the N_{L} strongest eigenvalues of H^{H} H as its diagonal elements. By applying the precoding matrix V at the precoding circuit 11 prior to transmission, and applying the shaping matrix U^{H} upon reception at the device 10, a diagonalization of the channel matrix H is attained; that is, the equivalent channel matrix becomes the diagonal matrix D, which implies N_{L} independent parallel subchannels for data transmission.

Of course, to determine the precoding matrix V, knowledge about the channel matrix H is needed. In some embodiments, such as those based on Frequency Division Duplexing, the transmitter 30 cannot itself estimate the channel; it is in these embodiments that SVD processing is carried out by the CSI reporting circuit 16 at the device 10, which reports back the precoding matrix V to the transmitter 30 as CSI. In doing so, the CSI reporting circuit 16 may report back only a quantized version of the precoding matrix V selected from a predefined set of precoding matrices (i.e., a codebook). Furthermore, if both the device 10 and the transmitter 30 are aware of the codebook, the CSI reporting circuit 16 may simply report back an index into the codebook, referred to as a precoding matrix indicator, PMI.

In any case, the control circuit 38 may select the precoding matrix V to be applied by the precoding circuit 44 based directly or indirectly on the precoding reported by the CSI reporting circuit 16 (e.g., a quantized precoding matrix or a PMI). Once precoded by the precoding circuit 44 in accordance with this selection, the precoded multi-antenna transmission 11 may be conditioned (e.g., converted to analog, filtered, amplified, and upconverted) by radio front-end 33 before being transmitted to the device 10 over transmit antennas 32.

Note that while the precoding circuit 44 was described above as applying the same precoding (i.e., the same precoding matrix V) across the entire bandwidth of the transmission 11, in some embodiments the precoding circuit 44 applies a different precoding (i.e., a different precoding matrix V) to different parts of the transmission bandwidth, referred to as sub-bands. For example, in embodiments based on orthogonal frequency division multiplexing (OFDM) communication systems, such as Long Term Evolution (LTE) and LTE-Advanced systems, the transmission bandwidth is divided into non-overlapping blocks of time-frequency resources called resource blocks (RBs). Adjacent RBs are grouped into sub-bands, with the number of RBs within a sub-band preferably depending on the coherence bandwidth of the channel. Precoding is then performed on a sub-band-by-sub-band basis, with a different precoding being applied to different groups of RBs (also referred to as precoding groups).

Correspondingly, in such embodiments, the CSI reporting circuit 16 at the device 10 determines the CSI by considering different possible precodings (i.e., different possible precoding matrices V) in different sub-bands of the transmission's bandwidth. Specifically, the CSI reporting circuit 16 forms a sequence of codewords for a given transmission rank by determining which codeword to add at a particular point in the sequence as follows: For each codeword c not yet added to the sequence, and for each sub-band s of the transmission's bandwidth, the CSI reporting circuit 16 determines the highest information rate Rₛ[c,s] expected for that codeword c in that sub-band s. In doing so, the CSI reporting circuit 16 considers all of the different rates possible for the codeword c in that sub-band s under different precodings p of the transmission 11 in that sub-band s (where pδP, a predetermined set of possible precodings).

The highest information rate Rₛ[c,s₁] for a codeword c in any given sub-band s₁ may therefore differ from the highest information rate Rₛ[c,s₂] for the codeword c in another sub-band s₂. But instead of deciding whether to add a codeword c to the sequence based on the codeword's information rate Rₛ[c,s] in any given sub-band s, which would impermissibly yield different decoding sequences for different sub-bands, the CSI reporting circuit 16 makes the decision based on a sum rate across all sub-bands. Specifically, the CSI reporting circuit 16 computes an individual information rate R[c] for the codeword c as the sum rate across all sub-band s (e.g., as the sum of Rₛ[c,s] for all s). This individual information rate R[c] thus in a sense represents the highest possible individual information rate for the codeword c if it is decoded at that point in the sequence, considering of course all of the different possible precodings p.

Next, with the aim of attaining the highest rate possible, the CSI reporting circuit 16 compares the individual information rates R[c] for those codewords c not yet added to the sequence, to determine the codeword x with the highest rate R[c]. The CSI reporting circuit 16 then adds that codeword x to the sequence at the point under consideration.

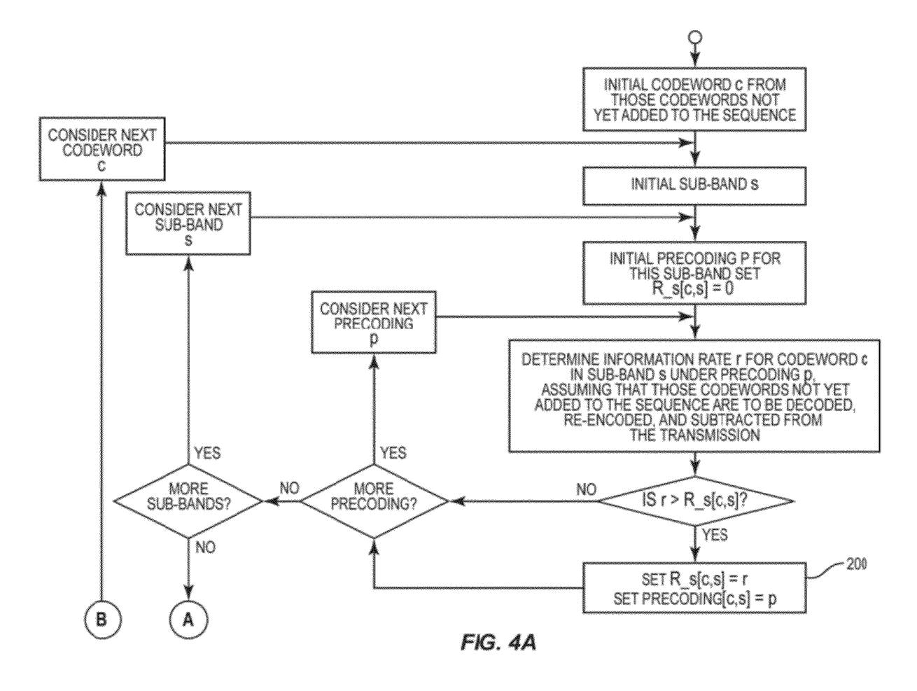

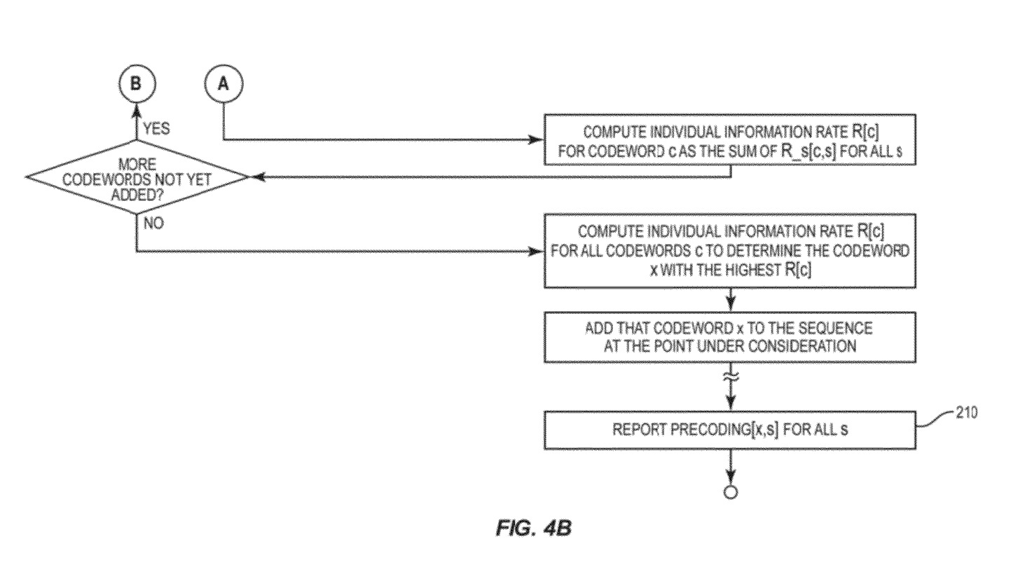

FIG. 4 illustrates logic for one simple implementation of this process, and further illustrates that the CSI reporting circuit 16 may keep track of the precodings p yielding the highest rate for each codeword c, for potential reporting of those precodings p. Notice, for example, in FIG. 4 that the CSI reporting circuit 16 at block 200 keeps track of Precoding[c,s] as the precoding p which yields the highest information rate Rₛ[c,s] expected for a codeword c in a particular sub-band s. Then, later, if the CSI reporting circuit 16 selects the transmission rank for which the sequence is being formed, it can report the precodings p yielding the highest rate for each codeword in that sequence on a sub-band-by-sub-band basis (Block 210). That is, while the CSI reporting circuit 16 determines a decoding sequence on a wideband basis (i.e., based on the sum rate of codewords across all sub-bands), the CSI reporting circuit 16 may still report per sub-band precodings p.

Note too that when the CSI reporting circuit 16 considers different precodings p of the transmission 11 and their effect on the information rate of a particular codeword c, the circuit 16 need not consider different precoding matrices V in their entirety. Indeed, only certain column vector(s) of a precoding matrix V affect the information rate of a particular codeword c, depending on the layer(s) to which that codeword are mapped. Thus, in some embodiments, the CSI reporting circuit 16 in considering different precodings p simply considers different precoding sub-matrices that operate on the layer(s) to which a particular codeword c is mapped. In reporting a precoding of the transmission 11, then, the CSI reporting circuit 16 reports a full precoding matrix V that comprises those precoding sub-matrices yielding the highest information rate for the codewords in the reported decoding sequence.

Alternatively or in addition to reporting precodings p on a sub-band-by-sub-band basis, the CSI reporting circuit may report CQI values on a sub-band-by-sub-band basis. In such embodiments, when the CSI reporting circuit 16 is determining the highest information rate Rₛ[c,s] expected for a codeword c in a particular sub-band s, the CSI reporting circuit 16 considers the different rates possible for the codeword c in that sub-band s under different MCSs for the codeword c. The CSI reporting circuit 16 may, for example, compute the information rate expected for the codeword c in that sub-band s under different MCSs and different precodings p, and then determine the combination of MCS and precoding that yields the highest rate.

Doing this for all sub-bands s, the CSI reporting circuit 16 sums the information rate Rₛ[c,s] for the codeword c across the sub-bands s, but keeps track of the corresponding MCS and/or precoding in each sub-band s for per sub-band reporting. In this way, the CSI reporting circuit 16 may form decoding sequences and select transmission rank based on wideband information rates, while reporting per sub-band precodings and/or CQI values for frequency selective scheduling of the transmission 11.

Note that in many embodiments the CSI reporting circuit 16 forms decoding sequences for different transmission ranks based on the assumption that the transmission 11 be allocated the same total transmit power regardless of which candidate transmission rank is selected. That is, the CSI reporting circuit 16 assumes that the transmitter 30 will split a given transmit power across however many layers over which the transmission 11 is sent.

This assumption proves particularly advantageous, though not inherently necessary, when precodings available for lower candidate transmission ranks are subsets of precodings available for higher candidate transmission ranks. As used herein, a candidate transmission rank is lower or higher relative to another candidate transmission rank depending on whether it maps codewords of the transmission 11 to a lower or higher number of layers, respectively. When a precoding available for a lower candidate transmission rank is a subset of a precoding available for a higher candidate transmission rank, the CSI reporting circuit 16 may form a decoding sequence for a higher rank based on a sequence already formed for a lower rank, thereby further reducing CSI reporting complexity.

As a specific example of this, consider the case where the same total transmit power is allocated to the transmission 11 regardless of its transmission rank. The CSI reporting circuit 16 in such embodiments may first form a sequence of codewords for a candidate transmission rank of one. Such amounts to determining the one codeword yielding the highest information rate, and the corresponding precoding for that codeword. Next, the CSI reporting circuit 16 may form a sequence of codewords for a candidate transmission rank of two, based on the sequence formed for rank one. In doing so, the CSI reporting circuit 16 simply adds an additional codeword to the front of the sequence formed for rank one and thus advantageously need only evaluate information rates for codewords decoded at that particular point in the sequence.

That is, with the precodings for rank two being a subset of the precodings for rank one, the precodings applicable to the first codeword added to the sequence for rank two are the same as the precodings applicable to the one codeword added to the sequence for rank one. Moreover, the interference from the second codeword yet to be added to the sequence for rank two will have been removed after the first stage of SIC reception. The highest information rate for the first codeword added to the sequence for rank two will therefore be identical, within a scaling factor, to the highest information rate for the one codeword added to the sequence for rank one, the scaling factor simply taking into account the division of the total transmit power across two codewords rather than just one. Accordingly, the CSI reporting circuit 16 need only adjust the highest information rate for the first codeword added to the sequence for rank two by a scaling factor, rather than having to re-evaluate information rates for each possible codeword and determine which yields the highest rate.

Those skilled in the art will of course appreciate that the above descriptions merely illustrate non-limiting examples that have been used primarily for explanatory purposes. For example, although embodiments of the present invention have been primarily described herein with respect to precoded, multi-antenna operation in LTE and LTE-Advanced systems, those skilled in the art will recognize that the inventive techniques disclosed and claimed herein are not so limited and may be advantageously applied to a wide array of precoded, multi-antenna wireless systems. Indeed, the wireless communication device 10 disclosed herein in a sense diverges from the LTE standards by permitting reception of more than only two codewords.

Those skilled in the art will also appreciate that a CQI value as used herein, whether reported for each sub-band or not, may be reported as a recommended information rate for a codeword, such as a recommended transport block size, or as a signal-to-noise-plus-interference ratio (SINR). In other embodiments, a CQI value is reported as a symbol mutual information value computed as a function of such SINR. In this regard, the CSI reporting circuit 16 may also represent the information rates used to determine the decoding sequence as symbol mutual information values.

Those skilled in the art will also appreciate that the wireless communication device 10 taught herein may comprise a mobile telephone, a Portable Digital Assistant, a laptop computer, or the like. These devices often operate with limited computing capabilities. Reductions in the complexity required for CSI reporting as described above would therefore better permit these devices to report CSI for a successively decoded, precoded multi-antenna transmission.

Those skilled in the art will further appreciate that the various “circuits” described may refer to a combination of analog and digital circuits, and/or one or more processors configured with software and/or firmware stored in memory that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method of channel state information reporting implemented by a wireless communication device configured to successively decode in a certain sequence one or more codewords of a forthcoming, precoded multi-antenna transmission, the method comprising:
forming, for each of a plurality of candidate transmission ranks of the transmission, a sequence of codewords by iteratively adding codewords allowed for that rank to the sequence, adding at any given point in the sequence the codeword expected to yield the highest individual information rate if decoded at that point in the sequence, considering the different rates possible under different precodings of the transmission;
computing, for each candidate transmission rank, a sum information rate across the codewords in the sequence formed for that rank, based on said highest individual information rates expected for those codewords if decoded in that sequence;
selecting the candidate transmission rank having the highest sum information rate; and
reporting channel state information that indicates the selected transmission rank and the sequence of codewords formed for that rank.

2. The method of claim 1, wherein said adding at any given point in the sequence comprises adding at any given point in the sequence the codeword expected to yield the highest individual information rate if decoded by:
decoding, re-encoding, and subtracting from the received transmission those codewords not yet added to the sequence; and
cancelling any interference due to those codewords already added to the sequence.

3. The method of claim 1, wherein reporting channel state information comprises reporting channel state information that also indicates the precoding of the transmission that yields the highest individual information rate expected for each codeword in the sequence of codewords formed for the selected transmission rank.

4. The method of claim 1, wherein considering the different rates possible comprises considering the different rates possible also under different modulation types for the codeword, and wherein reporting channel state information comprises reporting channel state information that also indicates, for each codeword in the sequence of codewords formed for the selected transmission rank, a channel quality information (CQI) value based on the modulation and coding scheme (MCS) for the codeword that yields the highest individual information rate expected for that codeword.

5. The method of claim 1, wherein forming, for each of a plurality of candidate transmission ranks of the transmission, a sequence of codewords by iteratively adding codewords allowed for that rank to the sequence comprises determining which codeword to add at any given point in the sequence by:
for each codeword not yet added to the sequence:
determining, for each of a plurality of sub-bands of the transmission bandwidth, the highest information rate expected for the codeword in that sub-band, considering the different rates possible for the codeword in that sub-band under different precodings of the transmission in that sub-band; and
computing an individual information rate for the codeword as a sum information rate across said sub-bands, based on said highest information rates expected for the codeword in those sub-bands;
comparing the individual information rates computed for the codewords not yet added to the sequence to determine the codeword with the highest individual information rate; and
adding to the sequence at said given point said codeword with the highest individual information rate.

6. The method of claim 5, wherein reporting channel state information comprises reporting channel state information that also indicates, for each of said sub-bands, the precoding of the transmission in that sub-band that yields the highest information rate expected for each codeword in the sequence of codewords formed for the selected transmission rank.

7. The method of claim 5, wherein determining, for each of a plurality of sub-bands of the transmission bandwidth, the highest information rate expected for the codeword in that sub-band, considering the different rates possible for the codeword in that sub-band under different precodings of the transmission in that sub-band comprises further considering the different rates possible for the codeword in that sub-band under different MCSs for the codeword.

8. The method of claim 7, wherein reporting channel state information comprises reporting channel state information that also indicates, for each codeword in the sequence of codewords formed for the selected transmission rank, and for each of said sub-bands, a CQI value based on the MCS for the codeword that yields the highest information rate expected for that codeword in that sub-band.

9. The method of claim 1, wherein forming, for each of a plurality of candidate transmission ranks of the transmission, a sequence of codewords by iteratively adding codewords allowed for that rank to the sequence comprises forming a sequence for each rank based on the assumption that the transmission be allocated the same total transmit power regardless of which candidate transmission rank is selected.

10. The method of claim 1, wherein a candidate transmission rank is lower or higher relative to another candidate transmission rank depending on whether it maps codewords of the transmission to a lower or higher number of layers, respectively, wherein different precodings are available for different candidate transmission ranks, a precoding available for a lower candidate transmission rank being a subset of a precoding available for a higher candidate transmission rank, and wherein forming, for each of a plurality of candidate transmission ranks of the transmission, a sequence of codewords comprises forming a sequence for a higher candidate transmission rank based on a sequence formed for a lower candidate transmission rank.

11. A wireless communication device comprising:
two or more receive antennas configured to receive a forthcoming, precoded multi-antenna transmission;
receive processing circuits configured to successively decode in a certain sequence one or more codewords of the transmission; and
a channel state information reporting circuit configured to:
form, for each of a plurality of candidate transmission ranks of the transmission, a sequence of codewords by iteratively adding codewords allowed for that rank to the sequence, adding at any given point in the sequence the codeword expected to yield the highest individual information rate if decoded at that point in the sequence, considering the different rates possible under different precodings of the transmission;
compute, for each candidate transmission rank, a sum information rate across the codewords in the sequence formed for that rank, based on said highest individual information rates expected for those codewords if decoded in that sequence;
select the candidate transmission rank having the highest sum information rate;
report channel state information that indicates the selected transmission rank and the sequence of codewords formed for that rank.

12. The wireless communication device of claim 11, wherein the channel state information reporting circuit is configured to add at any given point in the sequence the codeword expected to yield the highest individual information rate if decoded by:
decoding, re-encoding, and subtracting from the received transmission those codewords not yet added to the sequence; and
cancelling any interference due to those codewords already added to the sequence.

13. The wireless communication device of claim 11, wherein the channel state information reporting circuit is configured to report channel state information that also indicates the precoding of the transmission that yields the highest individual information rate expected for each codeword in the sequence of codewords formed for the selected transmission rank.

14. The wireless communication device of claim 11, wherein the channel state information reporting circuit is configured to consider the different rates possible under different precodings of the transmission and different MCSs for the codeword, and to report channel state information that also indicates, for each codeword in the sequence of codewords formed for the selected transmission rank, a CQI value based the MCS for the codeword that yields the highest individual information rate expected for that codeword.

15. The wireless communication device of claim 11, wherein the channel state information reporting circuit is configured to determine which codeword to add at any given point in the sequence by:
for each codeword not yet added to the sequence:
determining, for each of a plurality of sub-bands of the transmission bandwidth, the highest information rate expected for the codeword in that sub-band, considering the different rates possible for the codeword in that sub-band under different precodings of the transmission in that sub-band; and
computing an individual information rate for the codeword as a sum information rate across said sub-bands, based on said highest information rates expected for the codeword in those sub-bands;
comparing the individual information rates computed for the codewords not yet added to the sequence to determine the codeword with the highest individual information rate; and
adding to the sequence at said given point said codeword with the highest individual information rate.

16. The wireless communication device of claim 15, wherein the channel state information reporting circuit is configured to report channel state information that also indicates, for each of said sub-bands, the precoding of the transmission in that sub-band that yields the highest information rate expected for each codeword in the sequence of codewords formed for the selected transmission rank.

17. The wireless communication device of claim 15, wherein the channel state information reporting circuit is configured to further consider the different rates possible for the codeword in that sub-band under different MCSs for the codeword.

18. The wireless communication device of claim 17, wherein the channel state information reporting circuit is configured to report channel state information that also indicates, for each codeword in the sequence of codewords formed for the selected transmission rank, and for each of said sub-bands, a CQI value based on the MCS for the codeword that yields the highest information rate expected for that codeword in that sub-band.

19. The wireless communication device of claim 11, wherein the channel state information reporting circuit is configured to form a sequence for each rank based on the assumption that the transmission be allocated the same total transmit power regardless of which candidate transmission rank is selected.

20. The wireless communication device of claim 11, wherein a candidate transmission rank is lower or higher relative to another candidate transmission rank depending on whether it maps codewords of the transmission to a lower or higher number of layers, respectively, wherein different precodings are available for different candidate transmission ranks, a precoding available for a lower candidate transmission rank being a subset of a precoding available for a higher candidate transmission rank, and wherein the channel state information reporting circuit is configured to form a sequence for a higher candidate transmission rank based on a sequence formed for a lower candidate transmission rank.
